(19) United States
(12) Patent Application Publication
(10) Pub. No.: US 2023/0229769 A1
(43) Pub. Date: Jul. 20, 2023

(54) PREVENT NETWORK SPREAD OF MALWARE BY RESTRICTING IT TO ONE PATIENT ONLY

(71) Applicant: VMware, Inc., Palo Alto, CA (US)

(72) Inventors: Manisha Sameer Gambhir Parekh, Pune (IN); Pranav Narayan Gokhale, Pune (IN); Aditya Anil Gokhale, Pune (IN)

(21) Appl. No.: 17/966,807

(22) Filed: Oct. 15, 2022

(30) Foreign Application Priority Data
Jan. 14, 2022 (IN) 202241002321
Jan. 14, 2022 (IN) 202241002322
Jan. 14, 2022 (IN) 202241002323

(51) Int. Cl. G06F 21/56; G06F 21/53

(52) U.S. Cl. CPC G06F 21/565; G06F 21/53; G06F 2221/033

(57) ABSTRACT

Some embodiments provide a method of preventing network spread of malware files. At a first host computer, the method detects an attempt to establish a file-transfer connection between a first compute machine executing on the first host computer and a second compute machine executing on a second host computer, the file transfer connection for transferring a particular file stored by the first compute machine. The method delays establishment of the file-transfer connection in order to perform an analysis of the particular file to determine whether the particular file contains malware. When the file is determined to contain malware, the method prevents the file-transfer connection from being established between the first and the second compute machines to prevent the file from being transferred.

### BACKGROUND

Today, corporate networks deploy multiple sandboxing solutions that are managed by a central system. Any file downloaded is sent to be scanned for malware, and is sent to an offloaded scanning engine or system that subsequently returns a verdict to the machine where the file is downloaded. The verdicts are then synced between various scanning engines by the central system. Due to how quickly zero-day files can spread, the finite time that it takes to analyze and scan a file is ample for such malware to move across systems in a network.

### BRIEF SUMMARY

Some embodiments of the invention provide a method of preventing network spread of malware files. At a host computer executing in a datacenter, the method receives a request from a particular compute machine (e.g., a virtual machine (VM), container, pod, etc.) executing on the host computer to open a file that was downloaded to the host computer for the particular machine. The method determines whether the file is a known file that has been previously assessed to contain malware. Based on a determination that the file is unknown, the method allows the particular compute machine to open the file while also creating a record to identify the file as a file that is currently being analyzed to assess whether the file contains malware, and distributing the record to other host computers in the datacenter to ensure that the file cannot be opened on the other host computers until it has been analyzed to confirm that the file does not contain malware. As a result, even if the file is later determined to contain malware, the malware will have been isolated to the particular machine that opened it.

In some embodiments, the request to open the file is received as a notification from a guest introspection (GI) agent executing on the compute machine. For instance, in some embodiments, the GI agent on the compute machine registers hooks (e.g., callbacks) with one or more modules (e.g., kernel-space modules or user-space modules) in the compute machine's operating system for all new network connection events and all new process events, and based on a callback regarding a file-access event, the GI agent sends a notification of the file-access event to the host computer (e.g., a security hub executing on the host computer) and requests to open the file. In some embodiments, the notification communications from the GI agent are relayed to the host computer through a MUX.

The host computer, in some embodiments, has a database that includes records that map file hashes for known files and verdicts identifying whether the known files contain malware. In some embodiments, the host computer checks this database for a record associated with the file to determine whether the file associated with the request is a known file. When a record associated with the file does exist in the database, the host computer uses the record to determine whether the file has been identified as a file that contains malware, according to some embodiments. In some embodiments, when the file is in the process of being analyzed, the record specifies the same in order to indicate to host computers and forwarding devices (e.g., edge devices) that the file should not be opened or transferred while the analysis is in progress.

In some embodiments, in order to create and distribute the record for the file, the host computer first directs a static analysis module that executes within a container on the host computer to perform a sandboxing operation on the file to analyze and determine whether the file contains malware. This static analysis module, in some embodiments, communicates with a security analyzer operating separately from the host computer in the datacenter, and indicates to the security analyzer that the analysis of the file is in progress. In response, the security analyzer, in some embodiments, creates a record identifying the file as a file being analyzed to assess whether it contains malware, and distributes this record to the host computer and any other host computers in the datacenter. In other embodiments, the security analyzer instead notifies the host computer and other host computers in the datacenter of the status of the file, and each host computer creates a record for the file based on the status provided by the security analyzer.

In some embodiments, the static analysis module is unable to determine a verdict when analyzing the file, and the file is redirected to a centralized cloud service via a cloud connector proxy operating on the security analyzer. The centralized cloud service, in some embodiments, performs its own sandboxing operation on the file in order to determine whether the file contains malware. In some embodiments, the centralized cloud service includes a recordation service that stores profiles associated with files that contain malware, profiles associated with files that do not contain malware, and profiles associated with files that are currently being assessed for malware. When the analysis is completed, in some embodiments, the centralized cloud service then updates the record for the file (i.e., the record identifying the file as being assessed for malware) to reflect the determination of whether the file contains malware.

The determination is then provided (e.g., via the security analyzer) to host computers in the datacenter for use in evaluating subsequent attempts to open or transfer the file. Each host computer, in some embodiments, updates their existing record associated with the file (i.e., the record identifying the file as a known file being assessed for malware) with the received determination. Accordingly, upon receiving a subsequent request to open and/or transfer the file, each host computer can identify the file as a known file and either allow the file to be opened and/or transferred when the file does not contain malware, or deny the file from being opened and/or transferred when the file does contain malware and when the file's record indicates the file is being analyzed.

In some embodiments, rather than detecting and stopping a file at its destination, the file is instead detected and stopped at its source. For instance, some embodiments of the invention provide a method for a first host computer to detect an attempt to establish a file-transfer connection between a first compute machine executing on the first host computer and a second compute machine executing on a second host computer in order to transfer a file stored by the first compute machine to the second compute machine. In response to the detection, the method delays establishment of the file-transfer connection in order to perform an analysis of the file to determine whether it contains malware. When the file is determined to contain malware, the method prevents the file-transfer connection from being established between the first and the second compute machines to prevent the file from being transferred.

While the file is being analyzed at the source (i.e., first host computer), no machines (or applications) are allowed to open, copy, move, upload, or transfer the file, according to some embodiments. In some embodiments, the first and second host computers execute in the same datacenter, while in other embodiments, these host computers execute in different datacenters. Also, in some embodiments, the first and second host computers are the same host computer such that the first and second compute machines execute on the same host computer.

In some embodiments, rather than being detected at the source or the destination, an edge device that serves as a gateway between a datacenter and external networks detects the file. For instance, some embodiments of the invention provide a method for preventing network spread of malware files by receiving, at an edge device that provides a connection between a datacenter and an external network, a file destined to a machine executing in the datacenter. The method determines whether the file is a known file that has been previously assessed to contain malware. Based on a determination that the file as an unknown file, the method performs an analysis on the file. Like the embodiments described above, the file cannot be opened by any machines during the analysis. When the file is determined to be a file that does not contain malware, the method allows the file to be downloaded to and opened by the particular machine.

Like the host computers in the embodiments described above, the edge device, in some embodiments, also includes a database for storing records associated with known files, as well as a static analysis module that executes within a container on the edge device to perform the sandboxing operation to analyze files. In some embodiments, when a file is determined to contain malware, the edge device prevents the file from being opened and/or transferred by any machines in the datacenter. Also, in some embodiments, the edge device allows the machine to which the file is destined to download the file, and prevents the machine from opening the file until the file is determined to not contain malware. If the downloaded file is determined to contain malware, the machine will continue to be prevented from opening the file, according to some embodiments.

The preceding Summary is intended to serve as a brief introduction to some embodiments of the invention. It is not meant to be an introduction or overview of all inventive subject matter disclosed in this document. The Detailed Description that follows and the Drawings that are referred to in the Detailed Description will further describe the embodiments described in the Summary as well as other embodiments. Accordingly, to understand all the embodiments described by this document, a full review of the Summary, the Detailed Description, the Drawings, and the Claims is needed. Moreover, the claimed subject matters are not to be limited by the illustrative details in the Summary, the Detailed Description, and the Drawings.

### BRIEF DESCRIPTION OF FIGURES

The novel features of the invention are set forth in the appended claims. However, for purposes of explanation, several embodiments of the invention are set forth in the following figures.

FIGS. 1A-1B conceptually illustrate diagrams depicting various workflows between host computers, scanning engines, and a centralized cloud service, in some embodiments, when attempting to copy, transfer, or otherwise access an unknown file.

FIG. 2 conceptually illustrates a diagram of a workflow between datacenter components and a centralized cloud service for detecting and preventing network spread of malware at a host computer, in some embodiments.

FIG. 3 illustrates a more-detailed example of a host computer on which a static analysis module operates in some embodiments to perform sandboxing operations on files to assess the files for malware.

FIG. 4 illustrates a process for detecting and preventing the spread of malware at the destination, in some embodiments.

FIGS. 5A-5B illustrate diagrams showing workflows for detecting and preventing network spread of malware at the source, in some embodiments.

FIG. 6 illustrates a process for detecting and preventing the spread of malware at the source, in some embodiments.

FIG. 7 conceptually illustrates a process performed by the destination machine (e.g., a VM 305), application, or other element of some embodiments to attempt to open an unknown file.

FIG. 8 conceptually illustrates a diagram of a workflow between datacenter components and a centralized cloud service for detecting and preventing network spread of malware at an edge device for the datacenter, in some embodiments.

FIG. 9 illustrates a process for detecting and preventing the spread of malware at an edge device that provides a connection between a datacenter and an external network, in some embodiments.

FIG. 10 conceptually illustrates a computer system with which some embodiments of the invention are implemented.

### DETAILED DESCRIPTION

In the following detailed description of the invention, numerous details, examples, and embodiments of the invention are set forth and described. However, it will be clear and apparent to one skilled in the art that the invention is not limited to the embodiments set forth and that the invention may be practiced without some of the specific details and examples discussed.

Some embodiments of the invention provide a method of preventing network spread of malware files. At a host computer executing in a datacenter, the method receives a request from a particular compute machine (e.g., a virtual machine (VM), container, pod, etc.) executing on the host computer to open a file that was downloaded to the host computer for the particular machine. The method determines whether the file is a known file that has been previously assessed to contain malware. Based on a determination that the file is unknown, the method allows the particular compute machine to open the file while also creating a record to identify the file as a file that is currently being analyzed to assess whether the file contains malware, and distributing the record to other host computers in the datacenter to ensure that the file cannot be opened on the other host computers until it has been analyzed to confirm that the file does not contain malware. As a result, even if the file is later determined to contain malware, the malware will have been isolated to the particular machine that opened it.

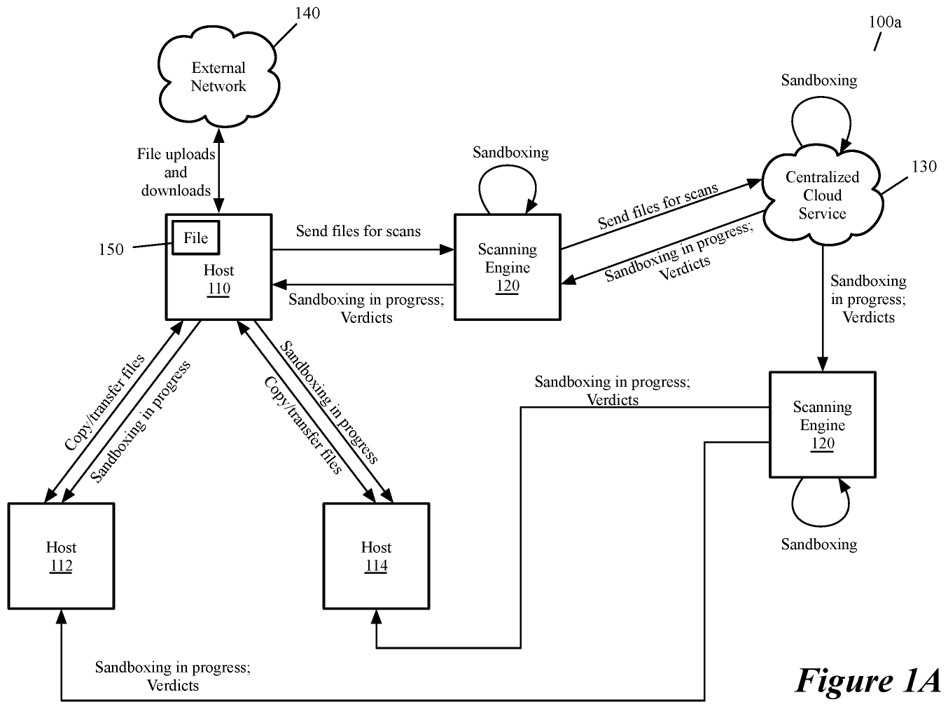

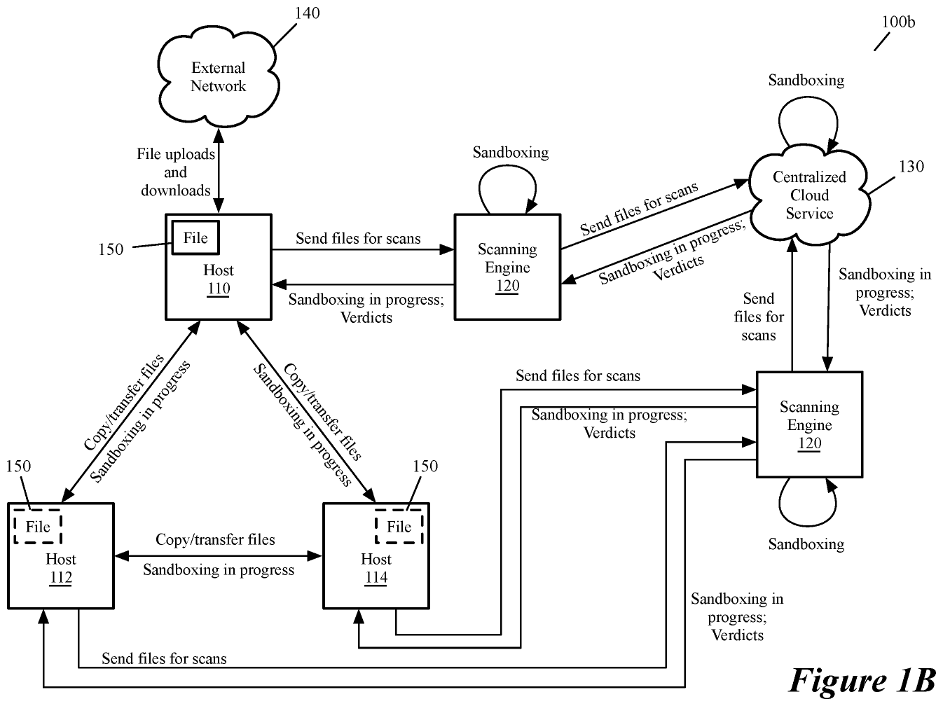

FIGS. 1A-1B conceptually illustrate diagrams 100a and 100b depicting various workflows between host computers, scanning engines, and a centralized cloud service, in some embodiments, when attempting to copy, transfer, or otherwise access an unknown file. As illustrated, each of the diagrams 100a and 100b include host computers 110, 112, and 114. Each of the host computers 110-114 have a connection to a respective scanning engine 120 that performs a sandboxing operation to determine whether files contain malware. Additionally, each of the scanning engines 120 include a connection to a centralized cloud service 130 that also performs a sandboxing operation (e.g., when the scanning engines 120 are unable to determine a verdict) and distributes status alerts (i.e., indicating sandboxing is in progress for a particular file) as well as verdicts (e.g., whether a particular file contains malware) to the scanning engines 120 for further distribution to the hosts 110-114.

In the diagram 100a, the host computer 110 has a connection to an external network 140, and stores a file 150. The host computer 110 can send the file 150 to the scanning engine 120 for analysis (e.g., sandboxing) to determine whether the file 150 contains malware. In some embodiments, the scanning engines 120 execute as part of the centralized cloud service 130. Also, in some embodiments, each of the host computers 110-114 hosts a static analysis module (not shown) that executes within a container running on the host and that performs a sandboxing operation without having to send any files to a scanning engine 120. In some embodiments, files are only sent to a scanning engine 120 when the static analysis module is unable to determine a verdict.

When the file 150 is sent for analysis (e.g., to the static analysis module on the host, to the scanning engine 120, etc.), a status update indicating sandboxing is in progress for the file 150 is distributed to each of the host computers 110-114. In some embodiments, this status update originates from the host computer 110 upon sending the file 150 for analysis, and is passed by the scanning engine 120 to the centralized cloud service 130, which distributes the update to all scanning engines 120 for distribution to all of the hosts 110-114. As will be described in the examples further below, a security analyzer (not shown) that operates in a same datacenter as the host computers 110-114 is responsible for receiving the status update from the centralized cloud service 130, and distributing the update to the hosts 110-114, according to some embodiments.

In some embodiments, each of the host computers 110-114 includes a database (not shown) for storing records that map file hashes for known files and verdicts identifying whether the known files contain malware. When a file-related event (e.g., file open event, file transfer event, etc.) is detected, in some embodiments, the host computer checks this database for a record for the file that is associated with the file-related event to determine whether the file is a known file, as well as whether the file is known to contain malware, or is currently being analyzed to assess whether it contains malware. When the host computers 110-114 receive an alert that a file is currently being analyzed (i.e., sandboxing is currently in progress for the file), each host creates a record that is associated with the file and indicates the file's status, and stores this record in its database, according to some embodiments. When a verdict associated with a file is received, the record for the file is updated, in some embodiments, and the file's status of sandboxing in progress is replaced with the received verdict.

During the sandboxing operation of some embodiments on the file 150 to assess the file for malware, any attempts to copy or transfer the file 150 by any of the host computers 110, 112, and 114, or any other elements internal or external to the same datacenter as the host 110 that stores the file, would be denied based on the file's status of sandboxing in progress. As illustrated, the host 110, in some embodiments, indicates to the hosts 112 and 114 that sandboxing is in progress for the file and thus the file cannot be copied or transferred (e.g., in response to a request from the hosts 112 and 114 to transfer or copy the file). In some embodiments, either of the host computers 112 and 114 may delay requesting to transfer and/or open the file based on the file's status of sandboxing in progress until an updated record that indicates a verdict for the file (i.e., the file does contain malware or the file does not contain malware) is received from the scanning engines 120, according to some embodiments. In some embodiments, the scanning engines receive all open requests for the file, and are responsible for denying such requests.

In the diagram 100b, the file 150 has been copied to each of the hosts 112 and 114, indicating the file does not contain malware. Because the file 150 is now a known file, and is known to not contain malware, subsequent attempts to open, copy, transfer, or otherwise access the file 150 will be granted (i.e., assuming no other policies prevent such attempts) based on the file's associated record stored by each host 110-114.

In some embodiments, if each of the files 150 on the hosts 110-114 were a different file, attempts to open, copy, transfer, or otherwise access each file would result in further sandboxing operations being performed. As illustrated, each of the host computers 110-114 can send files for scans to their respective scanning engines 120, and receive status updates indicating sandboxing is in progress, as well as verdicts once the sandboxing operations have been completed. The scanning engines 120 each can send files to the centralized cloud service 130 for scanning, and receive status updates and verdicts, as illustrated.

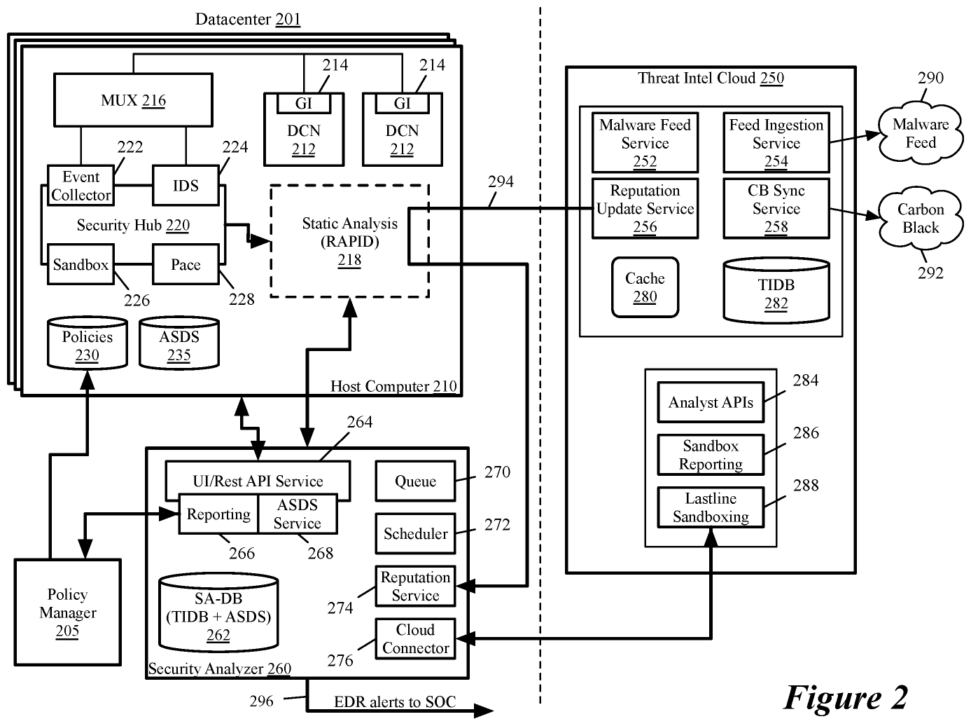

FIG. 2 conceptually illustrates a diagram of a workflow between datacenter components and a centralized cloud service for detecting and preventing network spread of malware at a host computer, in some embodiments. As shown, the datacenter 201 includes a set of host computers 210, a policy manager 205, and a security analyzer 260.

Each of the host computers 210 executes one or more DCNs 212 that communicate with a security hub 220 via a MUX (multiplexer) 216, a static analysis module 218, a policies storage 230, and an ASDS storage 235. The security hub 220 includes an event collector 222, an intrusion detection system (IDS) plugin 224, a sandbox plugin 226, and a pace plugin 228. In some embodiments, the MUX 216, policies storage 230, ASDS storage 235, and security hub 220 operate in the kernel space of the hypervisor, while the DCNs 212 operate in the hypervisor's user space. The static analysis module 218, in some embodiments, is a containerized service that also operates in the kernel space of the hypervisor.

The DCNs 212 are endpoint machines executing on the host computer 210. The DCNs are virtual machines (VMs) in some embodiments, containers in other embodiments, or a mix of VMs and containers in still other embodiments. On each DCN, a GI agent 214 executes in order to collect attributes and notify the security hub 220 of any file-transfer events and file-open events. In some embodiments, the security hub 220 receives event notifications from the GI agents 214 of the DCNs 212 on its host through a variety of different ways. For instance, in some embodiments, the GI agent on a DCN registers hooks (e.g., callbacks) with one or more modules (e.g., kernel-space modules or user-space modules) in the DCN's operating system for all new network connection events and all new process events.

Upon occurrence of a new file-transfer connection or file-open event, the GI agent 214 receives a callback from its DCN's OS and based on this callback, provides an event identifier to the security hub 220, in some embodiments. The event identifier provides a set of attributes pertaining to the event. These event attributes in some embodiments can include a five-tuple identifier (i.e., source port and IP address, destination port and IP address, and protocol) of the requested file-transfer connection, process identifier of the process requesting the file-transfer connection, a user identifier associated with the requesting process, and a group identifier (e.g., an activity directory (AD) identifier) associated with the requesting process.

The OS of the DCN 212 in some embodiments delays a new file-related event (e.g., delays establishment of a file-transfer connection) until the GI agent 214 on that DCN directs it to proceed with processing the event. In some of these embodiments, the GI agent 214 only allows the OS to proceed with processing the event after the security hub 220 has either determined that the file is known and does not contain malware, or has allowed the OS to proceed while the file is analyzed for malware.

The security hub 220, in some embodiments, is responsible for determining whether a file associated with a file-related event on one of the DCNs 212 is a known file, and whether the file is allowed to be accessed (e.g., opened, transferred, etc.). When a new event occurs, the event collector 222 receives the event notification from the GI agent 214 via the MUX 216. The IDS plugin 224, in some embodiments, monitors these events for known malicious activity and policy violations. In some embodiments, the IDS plugin 224 enforces policies from the policies storage 230. These policies, in some embodiments, include policies from the policy manager 205.

The ASDS storage 235 stores records that include mappings of file hashes for files known to the host computers 210 and verdicts indicating whether these files are known to contain malware. Upon receiving a notification of a new file-transfer connection event or file-open event, the security hub 220 checks the ASDS storage 235 to determine whether a record for the file associated with the event exists, indicating the file is a known file. When a record for the file does exist, the security hub 220 either allows the event to proceed or denies the event, based on whether the file is known to contain malware. In some embodiments, the record associated with a file may indicate a status for the file as “sandboxing in progress”. In some such embodiments, the file-related event would be delayed until a final verdict (i.e., does contain malware or does not contain malware) is received for the file.

The sandbox plugin 226, in some embodiments, points to a sandboxing environment, such as the static analysis module 218. When the security hub 220 determines that a file associated with an event detected by the GI agent 214, it sends the file to the static analysis module 218 for sandboxing. During the sandboxing operation, in some embodiments, the pace plugin 228 keeps track of the progress of the sandboxing operation.

In some embodiments, the static analysis module 218 communicates with the security analyzer 260 to inform the security analyzer when a sandboxing operation is in progress. In response, the ASDS service 268 of the security analyzer 218, in some embodiments, creates a record for the file that indicates that the file is being assessed for malware. This record is stored in the security analyzer database 262, and distributed via the reporting service 266 and API service 264 to the host computers 210. The host computers 210 then store the record in their respective ASDS storages 235. In other embodiments, the security analyzer instead provides a notification identifying the file and its status to the host computers, which use the notification to create their own records.

As indicated by the arrow 296, the security analyzer 260, in some embodiments, also sends endpoint detection and response (EDR) alerts conjunctively, or alternatively, to a security operations center (SOC) (not shown) and/or network operations center (NOC) (not shown). The SOC, in some embodiments, identifies, investigates, and resolves threats and cyber attacks, while the NOC ensures an enterprise's infrastructure is operating properly and meeting service level agreements, according to some embodiments. The EDR alerts provide information, such as analytic information, contextual information, etc., to the SOC and/or NOC about endpoint machines (e.g., host computers 210) in order for potentially malicious behavior to be identified, prevented, and remedied, in some embodiments. That is, in some embodiments, the EDR alerts are sent to the SOC and/or NOC in order to allow users (e.g., administrators of an enterprise network) of a UI for the SOC and/or NOC to review and determine whether to implement additional malware detection and/or prevention measures based on information in the received EDR alerts.

In some embodiments, the static analysis module 218 is unable to determine a verdict when analyzing a file, and the file is redirected to the centralized cloud service 250 (i.e., the threat intel cloud) via the cloud connector proxy 276 operating on the security analyzer 260. The queue 270 and scheduler 272 of the security analyzer 260, in some embodiments, are responsible for queuing and scheduling files to be directed to the centralized cloud service.

The cloud connector 276 provides files to the lastline sandboxing component 288 of the centralized cloud service 250, which performs its own sandboxing operation on files to assess files for malware. The sandbox reporting component 286 is responsible for reporting sandboxing results, in some embodiments, while the analyst APIs 284 are used for troubleshooting issues associated with the sandboxing operations.

The malware feed service 252 of the centralized cloud service 250 feeds data associated with sandboxing operations (e.g., verdicts and file hashes) through the feed ingestion service 254 to the malware feed 290. The carbon black (CB) sync service 258 is a recordation service that stores profiles associated with files that contain malware, profiles associated with files that do not contain malware, and profiles associated with files that are currently being assessed for malware in the carbon black repository 292. The cache 280 is a reputation cache, in some embodiments, that is updated with verdicts for files analyzed by the centralized cloud service 250. In some embodiments, the database 282 is also updated with a record associated with a newly sandboxed file, and the reputation update service 256 then provides the record to the reputation service 276 for updating records stored by the host computers 210. As illustrated by the connection 294, the reputation update service 256, in some embodiments, also provides the verdict to the static analysis module 218 on the host computer.

The determination is then provided (e.g., via the security analyzer) to host computers in the datacenter for use in evaluating subsequent attempts to open or transfer the file. Each host computer, in some embodiments, updates their existing record associated with the file (i.e., the record identifying the file as a known file being assessed for malware) with the received determination. Accordingly, upon receiving a subsequent request to open and/or transfer the file, each host computer can identify the file as a known file and either allow the file to be opened and/or transferred when the file does not contain malware, or deny the file from being opened and/or transferred when the file does contain malware.

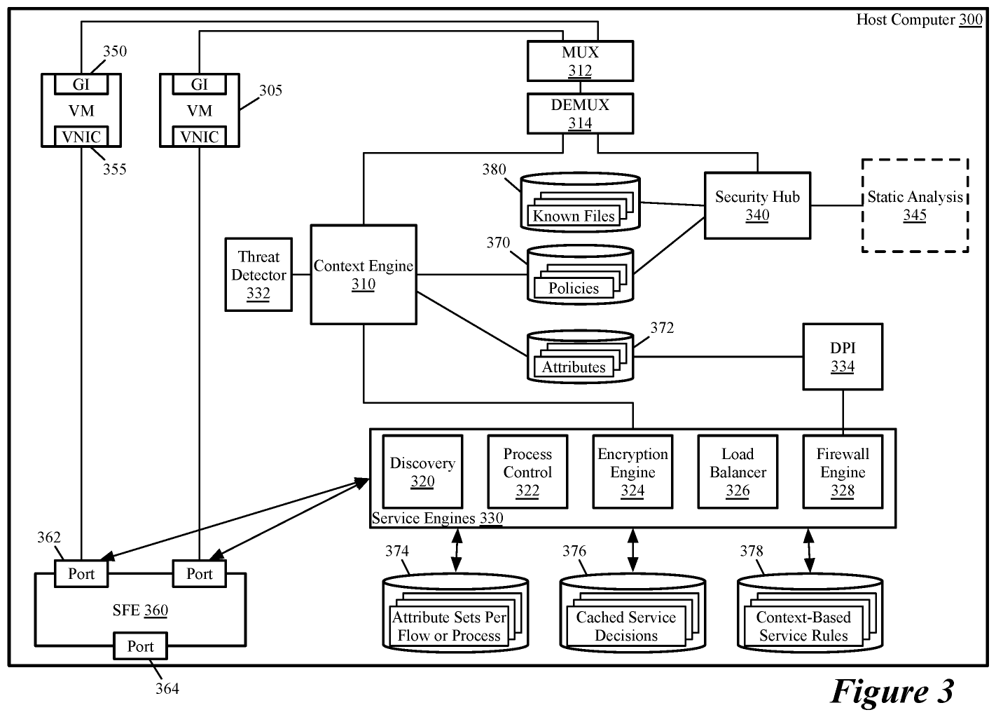

FIG. 3 illustrates a more-detailed example of a host computer 300 on which a static analysis module operates in some embodiments to perform sandboxing operations on files to assess the files for malware. Like the host computer 210, the host computer 300 includes a security hub 340, a static analysis module 345, a MUX 312, known files storage (i.e., ASDS) 380, and policies storage 370.

In FIG. 3, the DCNs are VMs 305 that execute on a hypervisor (not shown). In other embodiments, the DCNs are containers, or a mix of VMs and containers in still other embodiments. Also, in FIG. 3, the host computer 300 includes a context engine 310, service engines 330, threat detector 332, DPI module 334, a software forwarding element 360, a DEMUX (demultiplexer) 314, a context-attribute storage 372, an attribute-mapping storage 374, a connection state cache storage 376, and a context-based service rule storage 378. The service engines 330 include a discovery engine 320, a process control engine 322, an encryption engine 324, a load balancer 326, and a firewall engine 328.

In some embodiments, the context engine 310, the software forwarding element 360, the service engines 330, the context-based service rule storages 378, the connection state cache storage 376, the policy storage 370, and the MUX 312 operate in the kernel space of the hypervisor, while the VMs 305 operate in the hypervisor's user space. In other embodiments, one or more service engines are user space modules (e.g., are service VMs).

In some embodiments, the VMs 305 serve as data end points in the datacenter. Examples of such machines include webservers, application servers, database servers, etc. In some cases, all the VMs belong to one entity, e.g., an enterprise that operates the host. In other cases, the host 300 operates in a multi-tenant environment (e.g., in a multi-tenant data center), and different VMs 305 may belong to one tenant or to multiple tenants.

Each VM 305 includes a GI agent 350 that interacts with the security hub 340 to provide file-related event information to this module, and to receive instructions regarding whether to allow file-related events to proceed. The GI agents 350 also interact with the context engine 310 to provide context attribute sets to this engine, and to receive instructions and queries from this engine. As shown, all the communication between the security hub 340 and the GI agents 350, and between the context engine 310 and the GI agents 350, in some embodiments, are relayed through the MUX 312 and DEMUX 314. For instance, when the GI agents detect a file-related event, communications are sent to the MUX 312, then the DEMUX 314, which then provides the communications to both the context engine 310 and security hub 340. Alternatively, when a non-file-related event is detects, the DEMUX 314 provides associated communications to only the context engine 310 and not to the security hub 340, in some embodiments. One example of a MUX is the MUX that is used by the Endpoint Security (EPSec) platform of ESX hypervisors of VMware, Inc. In some embodiments, the GI agents communicate with the MUX 312 through a fast communication channel (such as VMCI channel of ESX). In some embodiments, this communication channel is a shared memory channel.

In some embodiments, the context engine also directs the GI agent 350 to collect from the OS modules additional process parameters that are associated with the process identifier (ID) that it received with the network event. These additional process parameters in some embodiments include the process name, the process hash, the process path with command line parameters, the process network connection, the process-loaded modules, and one or more process consumption parameters specifying the process' consumption of one or more resources of the machine (e.g., central processing unit consumption, network consumption, and memory consumption). Instead of using the process identifier to query the GI agent 350 for additional process parameters associated with a network event, the context engine 310 in other embodiments receives all the process parameters associated with a network event in one shot when the GI agent reports the network event to the context engine. In some embodiments, one or more of these identifiers and/or parameters are also provided to the security hub 340.

The OS of the DCN in some embodiments holds up a new network event (i.e., does not start sending data messages for the network event) until the GI agent 350 on that DCN directs it to proceed with processing the network event. In some of these embodiments, the GI agent 350 only allows the OS to proceed with processing a file-related event after the security hub 340 determines whether the associated file is known or unknown, and whether the file contains malware. For instance, as described above, the security hub 340 provides unknown files to the static analysis module 345 for sandboxing, which executes within a container on the host computer 300. The static analysis module 345, in some embodiments, notifies a security analyzer operating in a same datacenter (not shown) as the host computer 300 of the sandboxing operation in order to prevent any machines in the datacenter from accessing or transferring the file. As described above, the static analysis module 345, in some embodiments, sends the file to a centralized cloud service (via the security analyzer) for further sandboxing when the static analysis module 345 is unable to determine a verdict.

Additionally, in some embodiments, the OS of the VM is only allowed to process after the context engine 310 has collected all the needed attributes for this event (e.g., after receiving a message from the context engine that specifies that it has received all the process or network attributes that it needs for the new network event). The attributes collected by the context engine 310 from the GI agents 350 in some embodiments include a rich group of parameters (e.g., layer 7 parameters, process identifiers, user identifiers, group identifiers, process name, process hash, loaded module identifiers, consumption parameters, etc.).

The context engine 310 of some embodiments augments the contextual attributes that it receives from the GI agents 350 with contextual attributes that it receives from other modules that execute on the host. The DPI module 334 (also referred to as the deep packet inspector) and the threat detector 332 (also referred to as the threat inspection module) are two such modules that provide contextual attributes to augment those that the context engine collects from the GI agents 350. In some embodiments, a DPI module is directed by the context engine 310 or another module (e.g., a firewall engine 328) to examine data messages of a data message flow associated with a process ID to identify the type of traffic (i.e., AppID) being sent in these data messages by the application associated with the process ID.

The threat detector 332 provides a threat level indicator that specifies the threat level associated with a particular application that is executing on a DCN. Once the context engine obtains a set of process parameters that specify that a process has started on a machine or is sending data messages on the machine, the context engine in some embodiments provides one or more process parameters (e.g., process hash, application name, application version, AppID, other process parameters, etc.) to the threat detection module.

This threat detection module then generates a threat level indicator (e.g., low, medium, high, etc.) for the identified process and provides this threat level indicator to the context engine. In some embodiments, the threat detector assigns a threat score to an application running on a DCN based on various application behavioral factors, such as (1) whether it does poor input validation, (2) whether it passes authentication credentials over unencrypted network links, (3) whether it uses weak password and account policies, (4) whether it stores configuration secrets in clear text, (5) whether it can transfer files, (6) whether the application is known to propagate malware, (7) whether the application is purposely evasive, (8) whether the application has known vulnerabilities, etc. In some embodiments, the threat detector is a third-party whitelisting application, such as the Bit9.

The context engine in some embodiments provides the threat level indicator produced by the threat detector 332 to one or more service engines as another contextual attribute for performing services on a new process event or the data messages of a new network event; a service engine can use the threat level indicator as another attribute to identify service rules to enforce.

The context engine 310 stores the contextual attributes that it collects for network events and process events in the attribute storage 372. In some embodiments, the context engine stores each set of contextual attributes with one or more network event identifiers and/or process identifiers. For example, in some embodiments, the context engine 310 stores the collected contextual attributes for a new process event with the process identifier, or with a reference to this identifier. The context engine then uses the process identifier to provide the collected context attributes to a service engine (e.g., the process control engine 322) that performs a service for the process event.

In some embodiments, the context engine generates a service token (also called a service tag) for the collection of attributes that are relevant for the service engine, and provides this service token to another module (e.g., the GI agent or another module on the host) to pass along to the service engine (e.g., pass along in a data message's encapsulating header). The service engine then extracts the service token and provides this service token to the context engine in order to identify the contextual attributes that the context engine has to provide to the service engine.

As shown, each VM 305 also includes a virtual network interface card (VNIC) 355 in some embodiments. Each VNIC is responsible for exchanging messages between its VM and the software forwarding element (SFE) 360. Each VNIC connects to a particular port 362 of the SFE 360. The SFE 360 also connects to a physical network interface card (NIC) (not shown) of the host. In some embodiments, the VNICs are software abstractions created by the hypervisor of one or more physical NICs (PNICs) of the host.

In some embodiments, the SFE 360 maintains a single port 362 for each VNIC of each VM. The SFE 360 connects to the host PNIC (through a NIC driver (not shown)) to send outgoing messages and to receive incoming messages. In some embodiments, the SFE 360 is defined to include a port 364 that connects to the PNIC's driver to send and receive messages to and from the PNIC. The SFE 360 performs message-processing operations to forward messages that it receives on one of its ports to another one of its ports. For example, in some embodiments, the SFE tries to use data in the message (e.g., data in the message header) to match a message to flow based rules, and upon finding a match, to perform the action specified by the matching rule (e.g., to hand the message to one of its ports 362 or 364, which directs the message to be supplied to a destination VM or to the PNIC).

In some embodiments, the SFE 360 is a software switch, while in other embodiments it is a software router or a combined software switch/router. The SFE 360 in some embodiments implements one or more logical forwarding elements (e.g., logical switches or logical routers) with SFE executing on other hosts in a multi-host environment. A logical forwarding element in some embodiments can span multiple hosts to connect VMs that execute on different hosts but belong to one logical network.

Different logical forwarding elements can be defined to specify different logical networks for different users, and each logical forwarding element can be defined by multiple software forwarding elements on multiple hosts. Each logical forwarding element isolates the traffic of the VMs of one logical network from the VMs of another logical network that is serviced by another logical forwarding element. A logical forwarding element can connect VMs executing on the same host and/or different hosts. In some embodiments, the SFE extracts from a data message a logical network identifier (e.g., a VNI) and a MAC address. The SFE in these embodiments uses the extracted VNI to identify a logical port group, and then uses the MAC address to identify a port within the port group.

Software switches (e.g., software switches of hypervisors) are sometimes referred to as virtual switches because they operate in software and they provide the VMs with shared access to the PNIC(s) of the host. However, in this document, software switches are referred to as physical switches because they are items in the physical world. This terminology also differentiates software switches from logical switches, which are abstractions of the types of connections that are provided by the software switches. There are various mechanisms for creating logical switches from software switches. VXLAN provides one manner for creating such logical switches. The VXLAN standard is described in Mahalingam, Mallik; Dutt, Dinesh G.; et al. (2013 May 8), VXLAN: A Framework for Overlaying Virtualized Layer 2 Networks over Layer 3 Networks, IETF.

The ports of the SFE 360 in some embodiments include one or more function calls to one or more modules that implement special input/output (I/O) operations on incoming and outgoing messages that are received at the ports. Examples of I/O operations that are implemented by the ports 362 include ARP broadcast suppression operations and DHCP broadcast suppression operations, as described in U.S. Pat. No. 9,548,965. Other I/O operations (such as firewall operations, load-balancing operations, network address translation operations, etc.) can be so implemented in some embodiments of the invention. By implementing a stack of such function calls, the ports can implement a chain of I/O operations on incoming and/or outgoing messages in some embodiments. Also, in some embodiments, other modules in the data path (such as the VNICs 355, port 364, etc.) implement the I/O function call operations instead of, or in conjunction with, the ports 362.

In some embodiments, one or more of function calls of the SFE ports 362 can be to one or more service engines 330 that process context-based service rules in the context-based service rule storages 378. Each service engine 330 in some embodiments has its own context-based service rule storage 378, attribute-mapping storage 374, and connection state cache storage 376. FIG. 3 presents just one context-based service rule storage 378, attribute-mapping storage 374, and connection state cache storage 376 for all the service engines in order not to obscure the presentation in this figure with unnecessary detail. Also, in some embodiments, each VM has its own instance of each service engine 330 (e.g., its own instance of discovery engine 320, process control engine 322, encryption engine 324, load balancer 326, and firewall engine 328). In other embodiments, one service engine can service data message flows for multiple VMs on a host (e.g., VMs for the same logical network).

To perform its service operation for a data message flow, a service engine 330 in some embodiments tries to match the flow identifier (e.g., the five-tuple identifier) and/or the flow's associated context attribute set to the rule identifiers of its service rules in its context-based service rule storage 378. Specifically, for a service engine 330 to perform its service check operation for a data message flow, the SFE port 362 that calls the service engine supplies a set of attributes of a message that the port receives. In some embodiments, the set of attributes are message identifiers, such as traditional five-tuple identifiers. In some embodiments, one or more of the identifier values can be logical values that are defined for a logical network (e.g., can be IP addresses defined in a logical address space). In other embodiments, all of the identifier values are defined in the physical domains. In still other embodiments, some of the identifier values are defined in the logical domain, while other identifier values are defined in the physical domain.

The service engine in some embodiments then uses the received message's attribute set (e.g., the message's five-tuple identifier) to identify the context attribute set that the service engine has stored for this flow in the attribute-mapping storage 374. As mentioned above, the context engine 310 in some embodiments supplies the context attributes for new flows (i.e., new network connection events) and for new processes to the service engines 330, along with a flow identifier (e.g., a five-tuple identifier) or a process identifier. The policy storage 370 contains the rules that control the operation of the security hub 340 and the context engine 310, in some embodiments. In some embodiments, these policies direct the security hub to determine whether a record for a file associated with a file-related event exists in the known files storage 380, to provide the file to the static analysis module 345 when no such record exists, and to instruct the GI agent 350 to allow, delay, or prevent the file-related events from proceeding. Additionally, in some embodiments, the policies also direct context engine to generate rules for the service engines or to direct the service engines to generate rules (e.g., when a high-threat application runs on a VM, directing the encryption engine for all the other VMs on the same host to encrypt their data message traffic). The service engines 330 in these embodiments store the context attributes that they receive from the context engine in the attribute-mapping storage 374.

In some embodiments, a service engine 330 stores the context attribute set for each new flow or new process with that flow's identifier (e.g., five-tuple identifier) or that process' identifier in the attribute-mapping storage. In this manner, the service engine can identify the context attribute set for each new flow that it receives from the SFE ports 362 by searching its attribute-mapping storage 374 for a context record that has a matching flow identifier. The context record with the matching flow identifier includes the context attribute set for this flow. Similarly, to identify the context attribute set for a process event, a service engine in some embodiments searches its attribute-mapping storage 374 for a context record with a matching process identifier.

As mentioned above, some or all of the service engines in some embodiments pull the context attribute sets for a new flow or new process from the context engine. For instance, in some embodiments, a service engine supplies a new flow's five-tuple identifier that it receives from the SFE port 362, to the context engine 310. This engine 310 then examines its attribute storage 372 to identify a set of attributes that is stored for this five-tuple identifier, and then supplies this attribute set (or a subset of it that it obtains by filtering the identified attribute set for the service engine) to the service engine.

As described above, some embodiments implement the pull model by using a service token to encode the attribute set for a new message flow. When notified of a new network connection event, the context engine 310 in some embodiments (1) collects the context attribute set for the new event, (2) filters this set to discard the attributes that are not relevant for performing one or more services on the flow, (3) stores the remaining filtering attribute subset in the attribute storage 372 along with a service token, (4) provides the service token to the GI agent 350. The GI agent 350 then causes this token to be passed to the service engine(s) in-band (e.g., in a header of the data message that the agent's VM sends to a destination) or out-of-band (i.e., separately from the data messages that the agent's VM sends to a destination).

When the service engine gets the new flow through the SFE port 362, it supplies this flow's service token to the context engine, which uses this service token to identify in its attribute storage 372 the context attributes to supply to the service engine. In the embodiments that the SFE port does not provide this service token to the service engine, the service engine first has to identify the service token by searching its data stores using the flow's identifier before supplying the service token to the context engine.

After identifying the contextual attribute set for a data message flow, the service engine 330 in some embodiments performs its service operation based on service rules that are stored in the context-based service rule storage 378. To perform its service operation, the service engine 330 matches the received attribute subset with corresponding attribute sets that are stored for the service rules. In some embodiments, each service rule in the context-based service rule storage 378 has a rule identifier and an action parameter set.

As mentioned above, the rule identifier of a service rule in some embodiments can be defined in terms of one or more contextual attributes that are not L2-L4 header parameters (e.g., are L7 parameters, process identifiers, user identifiers, group identifiers, process name, process hash, loaded module identifiers, consumption parameters, etc.). In some embodiments, a rule identifier can also include L2-L4 header parameters. Also, in some embodiments, one or more parameters in a rule identifier can be specified in terms of an individual value or a wildcard value. Also, in some embodiments, a rule identifier can include a set of individual values or a group identifier, such as a security group identifier, a compute construct identifier, a network construct identifier, etc.

To match a received attribute set with the rules, the service engine compares the received attribute set with the associated identifiers of the service rules stored in the context-based service rule storage 378. Upon identifying a matching rule, the service engine 330 performs a service operation (e.g., a firewall operation, a load balancing operation, an encryption operation, other middlebox operation, etc.), based on the action parameter set (e.g., based on Allow/Drop parameters, the load balancing criteria, encryption parameters, etc.) of the matching rule.

In some embodiments, the context-based service rule storage 378 is defined in a hierarchical manner to ensure that a message rule check will match a higher priority rule before matching a lower priority rule, when the message's attribute subset matches multiple rules. Also, in some embodiments, the context-based service rule storage 378 contains a default rule that specifies a default action for any message rule check that cannot identify any other service rules; this default rule will be a match for all possible attribute subsets in some embodiments, and ensures that the service rule engine will return an action for all received attribute subsets. In some embodiments, the default rule will specify no service.

Multiple messages can have the same message identifier attribute sets, e.g., when the messages are part of one flow that is associated with one communication session between two machines. Accordingly, after matching a data message with a service rule in the context-based service rule storage 378 based on the message's identified context attribute set, the service engine of some embodiments stores the service rule (or a reference to the service rule) in the connection state cache storage 376, so that it can later use this service rule for subsequent data messages of the same flow.

In some embodiments, the connection state cache storage 376 stores the service rule, or a reference to the service rule, that the service engine 330 identifies for different message identifier sets (e.g., for different five-tuple identifiers that identify different data message flows). In some embodiments, the connection state cache storage 376 stores each service rule, or reference to the service rule, with an identifier (e.g., a flow's five-tuple identifier and/or a hash value of the flow's five-tuple identifier) that is generated from the matching message identifier set.

Before checking with the context-based service rule storage 378 for a particular message, the service rule engine 330 of some embodiments checks the connection state cache storage 376 to determine whether this storage has previously identified a service rule for this message's flow. If not, the service engine 330 identifies the contextual attribute set for the message flow, and then checks the context-based service rule storage 378 for a service rule that matches the message's identified attribute set and/or its five-tuple identifier. When the connection state data storage has an entry for the particular message, the service engine performs its service operation based on this service rule's action parameter set.

In the service architecture of FIG. 3, the DPI module 334 performs deep packet inspection on a data message flow at the direction of the firewall engine 328. Specifically, when the firewall engine 328 receives a new data message that is part of a new data message flow, the firewall engine in some embodiments directs the DPI module to inspect that new data message and one or more of the next few data messages in the same flow. Based on this examination, the DPI engine identifies the type of traffic (i.e., the application on the wire) that is being sent in this data message flow, generates an AppID for this traffic type, and stores this AppID in the attribute storage 372. In some embodiments, the context attribute sets are stored in the attribute storage based on flow identifiers and/or process identifier. Accordingly, in some embodiments, the DPI engine 334 stores the AppID for a new data message flow in the attribute storage 372 based on that flow's five-tuple identifier.

In some embodiments, the context engine 310 pushes to the service engines 330 the AppID for a new data message flow once the DPI engine stores the AppID in the attribute storage 372. In other embodiments, the context engine 310 pulls the AppID from the attribute storage 372 whenever it is queried for the contextual attributes for a data message flow by a service engine. In some embodiments, the context engine 310 uses the five-tuple identifier of the flow to identify the record in the attribute storage 372 with the matching record identifier and the AppID.

The firewall engine 328 performs firewall operations on data messages sent by or received for the DCNs 305. These firewall operations are based on firewall rules in the context-based service rule storage 378. Some of the firewall rules are defined purely in terms of layer 2-layer 4 attributes, e.g., in terms of five-tuple identifiers. Other firewall rules are defined in terms of contextual attributes that can include one or more of the collected contextual attributes, such as application names, application versions, AppID, resource consumption, threat level, user ID, group ID, etc. Yet other firewall rules in some embodiments are defined in terms of both L2-L4 parameters and contextual attributes. As the firewall engine 328 can resolve firewall rules that are defined by reference to contextual attributes, this firewall engine is referred to as a context-based firewall engine.

In some embodiments, the context-based firewall engine 328 can allow, block or re-route data message flows based on any number of contextual attributes, because its firewall rules can be identified in terms of any combination of the collected contextual attributes. For example, this firewall engine can block all email traffic from chrome.exe when the user is part of a Nurse user group, when one firewall rule specifies that data messages should be blocked when the flow is associated with the Nurse group ID, the AppID identifies the traffic type as email, and the application name is Chrome. Similarly, context based firewall rules can block data message flows associated with video conferences, online video viewing, or use of old versions of software. Examples of such rules would block all Skype traffic, block all YouTube video traffic, block all HipChat audio/video conferences when application version number is older than a particular version number, block data message flows for any application with a high threat score, etc.

The load-balancing engine 326 performs load-balancing operations on data messages sent by the DCNs 305 to distribute the data message flows to different destination or service nodes in one or more destination/service node clusters. These load-balancing operations are based on load-balancing rules in the context-based service rule storage 378. In some of these embodiments, each load-balancing rule can specify one or more load-balancing criteria (e.g. a round robin criterion, a weighted round-robin criteria, etc.) for distributing traffic, and each criteria can be limited to a particular time range. In some embodiments, a load-balancing operation involves replacing a data message flow's destination network address (e.g., the destination IP address, the destination MAC address, etc.) with another destination network address.

Some of the load-balancing rules are defined purely in terms of L2-L4 attributes, e.g., in terms of five-tuple identifiers. Other load-balancing rules are defined in terms of contextual attributes that can include one or more of the collected contextual attributes, such as application names, application versions, AppID, resource consumption, threat level, user ID, group ID, etc. Yet other load-balancing rules in some embodiments are defined in terms of both L2-L4 parameters and contextual attributes. As the load-balancing engine 326 can resolve load-balancing rules that are defined by reference to contextual attributes, this load-balancing engine is referred to as a context-based load balancer.

In some embodiments, the context-based load balancer 326 can distribute the data message flows based on any number of contextual attributes, because its load-balancing rules can be identified in terms of any combination of the collected contextual attributes. For example, the data distribution of the load balancer 326 can be based on any combination of user and application data. Examples of such load-balancing operations include: (1) distributing data message flows associated with the Finance department on all load-balancing pools, (2) redirecting all the Finance department's traffic to another pool when the primary pool for this department is down to make this department's traffic highly available, and (3) making all traffic associated with the Doctor's user group highly available. In some embodiments, the load-balancing rules can also be defined in terms of collected resource consumption, in order to distribute traffic to provide more or less resources to applications that consume a lot of resources on the DCNs.

The encryption engine 324 performs encryption/decryption operations (collectively referred to as encryption operations) on data messages sent by or received for the DCNs 305. These encryption operations are based on encryption rules in the context-based service rule storage 378. In some embodiments, each of these rules includes an encryption/decryption key identifier, which the encryption engine can use to retrieve an encryption/decryption key from a key manager on the host or operating outside of the host. Each encryption rule also specifies in some embodiments the type of encryption/decryption operation that the encryption module has to perform.

Each encryption rule also has a rule identifier. For some encryption rules, the rule identifiers are defined purely in terms of L2-L4 attributes, e.g., in terms of five-tuple identifiers. Other encryption rules are defined in terms of contextual attributes that can include one or more of the collected contextual attributes, such as application names, application versions, AppID, resource consumption, threat level, user ID, group ID, etc. Yet other encryption rules in some embodiments are defined in terms of both L2-L4 parameters and contextual attributes. As the encryption engine 324 can resolve encryption rules that are defined by reference to contextual attributes, this encryption engine is referred to as a context-based encryption engine.

In some embodiments, the context-based encryption module 324 can encrypt or decrypt the data message flows based on any number of contextual attributes because its encryption rules can be identified in terms of any combination of the collected contextual attributes. For example, the encryption/decryption operation of the encryption engine 324 can be based on any combination of user and application data. Examples of such encryption operations include: (1) encrypt all traffic from Outlook (started on any machine) to Exchange Server, (2) encrypt all communication between applications in a three tier Webserver, Application Server and Database Server, (3) encrypt all traffic originating from the Administrators Active Directory group, etc.

The process control engine 322 enforces context-based process control operations (e.g., process assessment and termination operations) on processes started on the DCNs 305. In some embodiments, whenever the context engine 310 receives a new process event from a GI agent 350 of a DCN, it provides the process parameters associated with this process event to the process control engine 322. This engine then uses the received set of process parameters to examine its context-based service rule storage 378 to identify a matching context-based, process-control rule.

The process control engine 322 can direct the context engine to direct the GI agent of the DCN to perform a process-control operation on a process. Examples of such process-control operations include (1) terminating a video conference application that has a particular version number, (2) terminating a browser that is displaying YouTube traffic, and (3) terminating applications that have a high threat level score.

The discovery engine 320 is another context-based service engine. In some embodiments, the discovery engine 320 captures new process events and new network events from the context engine, along with the contextual attributes that the context engine collects for these process and network events. As further described below, the discovery service engine then relays these events and their associated contextual attributes to one or more network managers (e.g., servers) that provide a management layer that allows network administrators to visualize events in a datacenter and specify policies for compute and network resources in the datacenter.

In relaying these events and attributes to the network management layer, the discovery module of some embodiments performs some pre-processing of these events and attributes. For example, in some embodiments, the discovery module filters some of the network or process events, while aggregating some or all of these events and their attributes. Also, in some embodiments, the discovery engine 320 directs the context engine 310 to collect additional contextual attributes for process or network events through the GI agents 350 or other modules (e.g., the DPI engine or threat detection engine), or to capture other types of events, such as file events and system events.

For example, in some embodiments, the discovery engine directs the context engine to build an inventory of the applications installed on the machines, and to periodically refresh this inventory. The discovery engine might so direct the context engine at the request of the management plane, or based on operational configurations that the management or control plane specifies for the discovery engine. In response to the request from the discovery engine, the context engine in some embodiments has each GI agent on each of its host's machine discover all installed processes on the machine, and all running processes and services.

After building an inventory of installed applications and the running processes/services, the discovery engine of a host computer in a datacenter provides this information to the network/compute managers in the management plane. In some embodiments, the management plane collects contextual attributes from sources other than the host computer discovery and context engines. For instance, in some embodiments, the management plane collects from one or more servers compute context (e.g., cloud context from cloud vendors, or compute virtualization context by datacenter virtualization software), identity context from directory service servers, mobility context from mobility management servers, endpoint context from DNS (domain name server) and application inventory servers, network context (e.g., virtual network context from network virtualization server), etc.

By collecting the contextual information (e.g., information from the discovery and context engines and/or information from other context sources), the management plane can provide a user interface to the network/compute administrators to visualize the compute and network resources in the datacenter. Moreover, the collected contextual attributes allow the management plane to provide controls through this user interface for these administrators to specify context-based service rules and/or policies. These service rules/policies are then distributed to the host computers so that service engines on these computers can perform context-based service operations.

In some embodiments described above, the same service engine 330 (e.g., the same firewall engine 328) performs the same type of service (e.g., a firewall service) based on service rules that can be defined in terms of message flow identifiers (e.g., five-tuple identifiers) or in terms of collected contextual attributes (e.g., AppID, threat level, user identifier, group identifier, application name/version, etc.) associated with the data message flows. In other embodiments, however, different service engines provide the same type of service based on the message flow identifiers (e.g., five-tuple identifiers) and based the collected contextual attributes of the data message flows. For instance, some embodiments use one flow-based firewall engine that performs firewall operations based on rules defined in terms of flow identifiers, and another context-based firewall engine that performs firewall operations based on rules defined in terms of context attributes (e.g., AppID, threat level, user identifier, group identifier, application name/version, etc.).

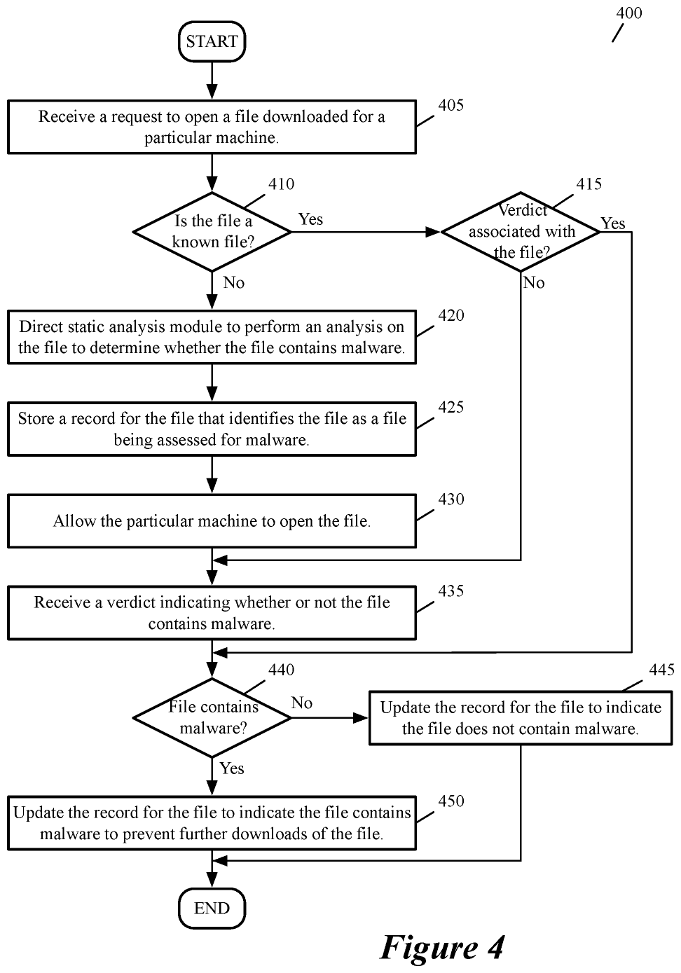

FIG. 4 illustrates a process for detecting and preventing the spread of malware at the destination, in some embodiments. The process 400 is performed, in some embodiments, by components of the destination host computer, such as in the example described above for FIG. 2. While the process 400 will be described with reference to a machine to which a file is destined, files in other embodiments of the invention may be destined to host computers themselves, applications executing on the host computers, etc.

The process 400 starts by receiving (at 405) a request to open a file downloaded for a particular machine. As described above, the security hub 220 of the host computer 210 receives event notifications from the GI agents 214. These event notifications, in some embodiments, include file-open events and the GI agents 214 include requests to open files associated with these events in the event notifications.

The process determines (at 410) whether the file is a known file. Upon receiving a notification of a file-related event, the security hub 220 is configured to check the ASDS storage 235, which stores records for known files, for a record associated with the file. When the process determines (at 410) that the file is a known file, the process transitions to determine (at 415) whether there is a verdict (i.e., contains malware or does not contain malware) associated with the file. That is, the process determines whether the record for the file indicates whether or not the file contains malware.

When the process determines (at 415) that there is no verdict associated with the file, the process transitions to receive (at 435) a verdict indicating whether or not the file contains malware. Alternatively, when the process determines (at 415) that there is a verdict associated with the file, the process transitions to determine (at 440) whether the verdict indicates the file contains malware.

Otherwise, when the process determines (at 410) that the file is an unknown file, the process transitions to direct (at 420) a static analysis module to perform an analysis on the file to determine whether the file contains malware. In some embodiments, the static analysis module 218 is able to perform a sandboxing operation on the file. However, in some embodiments, the static analysis module 218 is unable to reach a verdict, and redirects the file to the centralized cloud service 250 for analysis via the cloud connector 276.

The process stores (at 425) a record for the file that identifies the file as a file being assessed for malware. This record, in some embodiments, is created by the host computer 210 in response to receiving a notification that sandboxing is in progress for the file. In other embodiments, the host computer 210 receives a record from the security analyzer 260 for the file, and stores this record in the ASDS storage 235. The security analyzer 260 also provides the record to each of the host computers 210, as mentioned above. In other embodiments, steps 420 and 425 are performed concurrently, while in still other embodiments, step 425 is performed before step 420.

The process allows (at 430) the particular machine to open the file. In some embodiments, in order to ensure a good user experience, the file is allowed to be opened by the machine that received the file. However, in some embodiments, no other machines are allowed to open the file until the sandboxing is completed and the file is determined to not contain malware.

The process receives (at 435) a verdict indicating whether or not the file contains malware. The ASDS service 268 of the security analyzer 260 sprays the verdicts to all of the host computers 210, according to some embodiments. That is, after receiving a verdict via the reputation service 272, in some embodiments, the ASDS service then distributes this verdict to other elements of the datacenter.

The process determines (at 440) whether the verdict indicates the file contains malware. When the process determines (at 440) that the verdict indicates that the file does not contain malware, the process transitions to update (at 445) the record (i.e., the record stored in the ASDS storage 235) for the file to indicate the file does not contain malware. Following 445, the process 400 ends. Alternatively, when the process determines (at 440) that the verdict indicates that the file does contain malware, the process transitions to update (at 450) the record for the file to indicate the file contains malware to prevent further downloads of the file. Following 450, the process 400 ends.

In some embodiments, rather than detecting and stopping a file at its destination, the file is instead detected and stopped at its source. For instance, some embodiments of the invention provide a method for a first host computer to detect an attempt to establish a file-transfer connection between a first compute machine executing on the first host computer and a second compute machine executing on a second host computer in order to transfer a file stored by the first compute machine to the second compute machine. In response to the detection, the method delays establishment of the file-transfer connection in order to perform an analysis of the file to determine whether it contains malware. When the file is determined to contain malware, the method prevents the file-transfer connection from being established between the first and the second compute machines to prevent the file from being transferred.

While the file is being analyzed at the source (i.e., first host computer), no machines (or applications) are allowed to open, copy, move, upload, or transfer the file, according to some embodiments. In some embodiments, the first and second host computers execute in the same datacenter, while in other embodiments, these host computers execute in different datacenters. Also, in some embodiments, the first and second host computers are the same host computer such that the first and second compute machines execute on the same host computer.

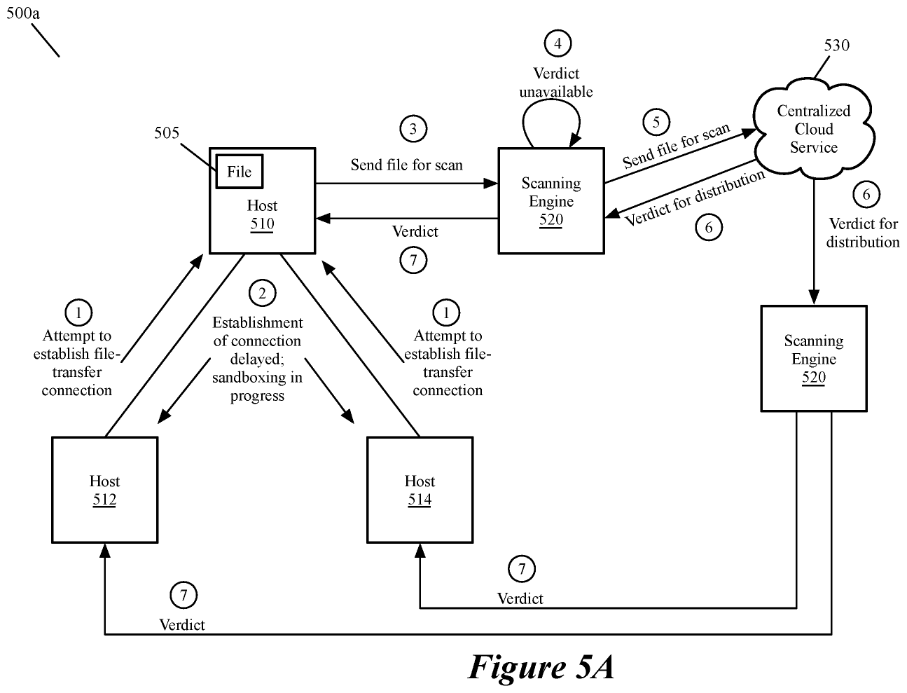

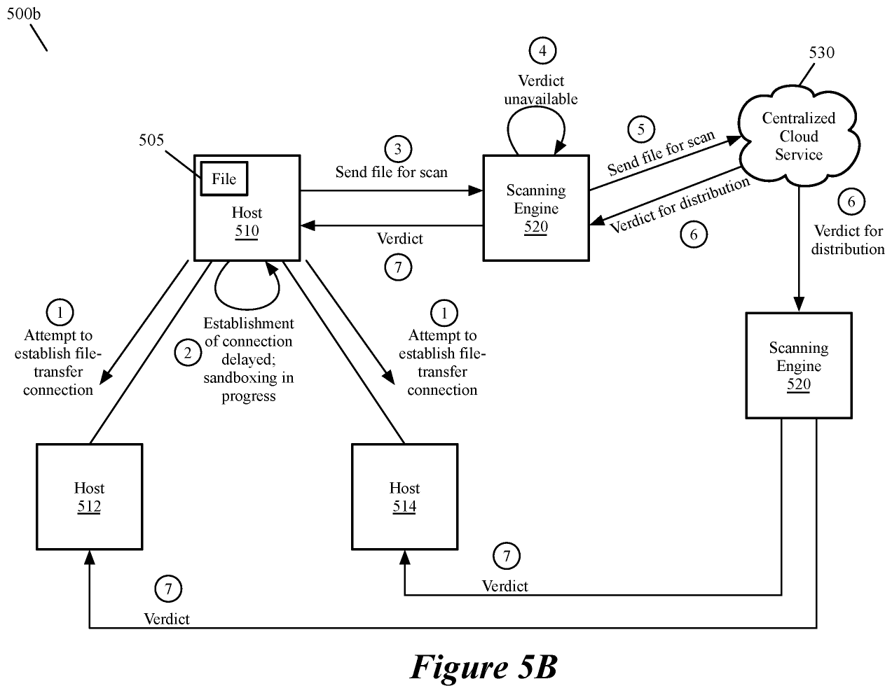

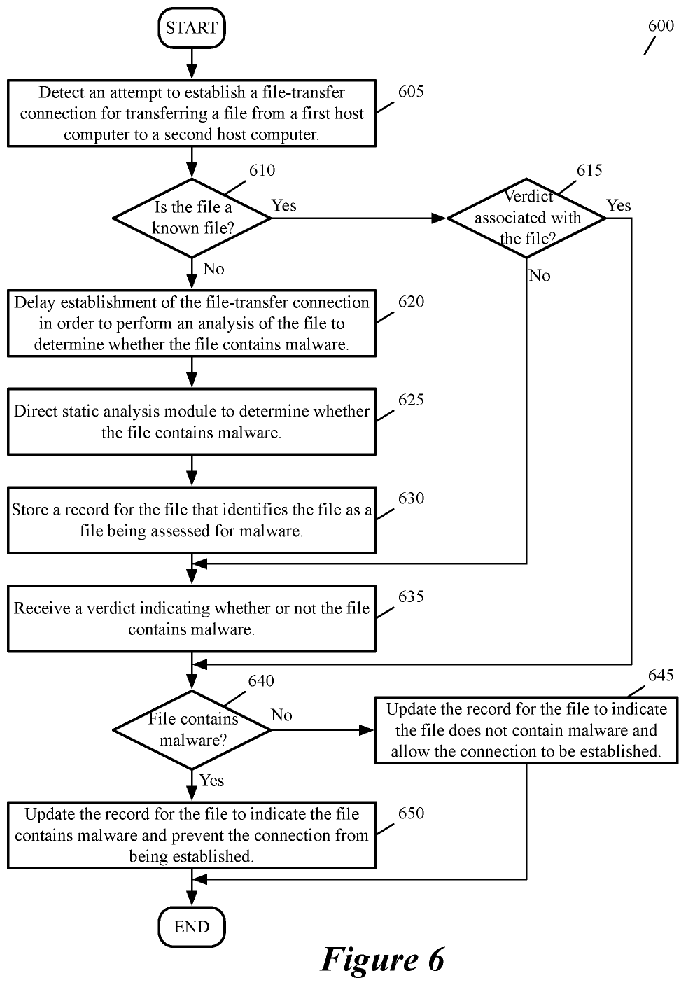

FIGS. 5A-5B illustrate diagrams 500a and 500b showing workflows for detecting and preventing network spread of malware at the source, in some embodiments. As illustrated, the diagrams 500a and 500b both include a set of host computers (e.g., 510, 512, and 514), scanning engines 520, and a centralized cloud service 530. The workflow diagrams 500a and 500b will be described below by reference from FIG. 6, which illustrates a process for detecting and preventing the spread of malware at the source, in some embodiments.

The process 600 is performed, in some embodiments, by components of the source host computer. The process 600 starts by detecting (at 605) an attempt to establish a file-transfer connection for transferring a file from a first host computer to a second host computer. For instance, the host computers 512 and 514 are illustrated in the diagram 500a as attempting to establish file-transfer connections with the host computer 510, which stores a file 505. The hosts 512 and 514, in some embodiments, attempt to establish the file-transfer connection by sending a request to the host 510 for the file 505.

In some embodiments, rather than either of the host computers 512 and 514 requesting the file 505 from the host computer 510, the host 510 attempts to establish file-transfer connections with one or each of the hosts 512 and 514. In the diagram 500b, for instance, the host 510 is illustrated (at the encircled 1) as attempting to establish file-transfer connections with the hosts 512 and 514. In other embodiments, an existing connection between hosts may be hijacked (i.e., instead of establishing a new connection) in order to spread the file to other hosts.

The process determines (at 610) whether the file is a known file. As described above, the host computer checks a storage for a record associated with the file to determine whether it is a known file that has already been scanned, or sent for a scan, to determine whether the file contains malware. When the process determines (at 610) that the file is a known file, the process transitions to determine (at 615) whether there is a verdict (i.e., contains malware or does not contain malware) associated with the file.

When the process determines (at 615) that there is no verdict associated with the file, the process transitions to receive (at 635) a verdict indicating whether or not the file contains malware. The verdict is received by the host computer 510 (i.e., the source host computer), in some embodiments, from a static analysis module executing within a container (not shown) on the host 510, while in other embodiments, the verdict is received from a scanning engine 520. Alternatively, when the process determines (at 615) that there is a verdict associated with the file, the process transitions to determine (at 640) whether the verdict indicates the file contains malware.

When the process instead determines (at 610) that the file is an unknown file, the process transitions to delay (at 620) establishment of the file-transfer connection in order to perform an analysis of the file to determine whether the file contains malware. In the diagram 500a, for example, the host computer 510 delays (at the encircled 2) the establishment of the file-transfer connection with the hosts 512 and 514 when the file 505 is determined to be unknown and indicates to the hosts 512 and 514 that the sandboxing is in progress. Also, while the sandboxing in progress updates are illustrated as coming from the host 510, these sandboxing in progress updates are also distributed to all of the hosts by the centralized cloud service 530 via the scanning engines 520, as described in the embodiments above, and as illustrated by the diagrams 100a and 100b. In some embodiments, an application (not shown) on the host computer 510 that is attempting to transfer the file 505 is also notified by the host 510 that sandboxing is in progress for the file and that the file transfer operation (or other file-related operation) cannot be completed until a verdict has been reached.

The process directs (at 625) a static analysis module to perform an analysis on the file to determine whether the file contains malware. In some embodiments, the host computer 510 sends the file to a scanning engine 520 for analysis. The scanning engines 520, in some embodiments, are components of the centralized cloud service 530. In some embodiments, the file is only sent to the centralized cloud service 530 when a containerized analysis module (not shown) on the host computer is unable to reach a verdict. In the diagrams 500a and 500b, for instance, the host 510 sends the file 505 to the scanning engine 520 (at the encircled 3) for scanning and analysis, and the upon determining that a verdict is unavailable (at the encircled 4), the scanning engine 520 sends the file (at the encircled 5) for analysis by the centralized cloud service 530.

The process stores (at 630) a record for the file that identifies the file as a file being assessed for malware. In some embodiments, this record is received from the scanning engine 520. In other embodiments, the host computer 510 creates a record for the file 505 and stores this record. In some such embodiments, the record may be based on a notification from the scanning engine 520 indicating sandboxing is in progress. In some embodiments, steps 620, 625, and 630 are performed simultaneously. In other embodiments, step 630 may be performed before the file is sent for scanning at step 625.

The process receives (at 635) a verdict indicating whether or not the file contains malware. As illustrated in the diagram 500, the host computer 510 receives a verdict from the scanning engine 520. This verdict, in some embodiments, is generated by the centralized cloud service 530 and provided to the scanning engines 520 for distribution to the host computers. For instance, in each of the diagrams 500a and 500b, the centralized cloud service 530 provides the verdict for distribution (at the encircled 6) to the scanning engines 520, which subsequently distribute the verdict (at the encircled 7) to each of the hosts 510-514.

The process determines (at 640) whether the verdict indicates the file contains malware. When the process determines (at 640) that the verdict indicates that the file does not contain malware, the process transitions to update (at 645) the record (i.e., the record stored in the ASDS storage of the host computer) for the file to indicate the file does not contain malware and to allow the file-transfer connection to be established. Following 645, the process 600 ends.

Alternatively, when the process determines (at 640) that the verdict indicates that the file does contain malware, the process transitions to update (at 650) the record for the file to indicate the file contains malware and to prevent the file-transfer connection from being established, thereby preventing the file from be transferred. In some such embodiments, future attempts to access the file (e.g., to open, transfer, copy, etc. the file) will be denied based on the verdict associated with the file and stored in the file's record. Following 650, the process 600 ends.

In some embodiments, rather than attempts to transfer or copy an unknown file in response to requests for the file, or when a source host attempts to send the file to other hosts, a different payload can hijack a connection between a source host and a destination host and be dropped on the destination host, at which point a new file is created. The new file can subsequently attempt to use another connection (e.g., another connection between the destination host on which it was created and a different host) to attempt to continue to spread to other host computers, according to some embodiments, without intervention by the workflows described above.

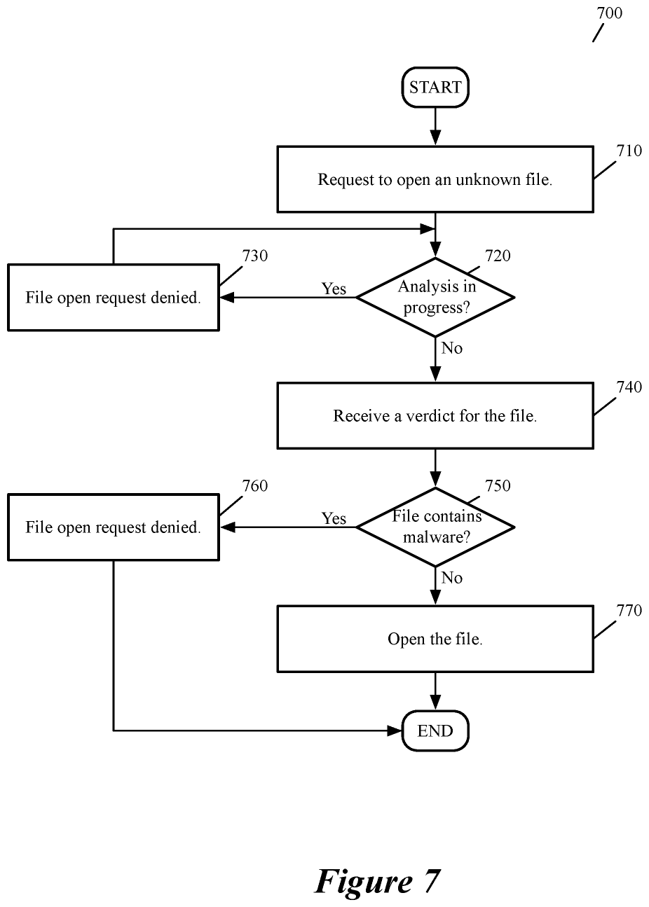

FIG. 7 conceptually illustrates a process performed by the destination machine (e.g., a VM 305), application, or other element of some embodiments to attempt to open an unknown file. The process 700 starts by requesting (at 710) to open an unknown file. In some embodiments, the request is made by a GI agent on a compute machine based on a callback received from the compute machine's OS indicating the compute machine is attempting to open the unknown file.

The process determines (at 720) whether analysis on the file is in progress. That is, the process determines whether a sandboxing operation to determine whether the file contains malware is currently being performed. As described above, when a file is being analyzed for malware, attempts to open, copy, transfer, or otherwise access the file are denied in order to prevent any spread of potential malware and keep the potential malware contained to a single patient. Accordingly, when the process determines (at 720) that an analysis is in progress for the file, the file open request is denied (at 730) and the process loops back to 720 until the process determines (at 720) that analysis is no longer in progress for the file.

The process receives (at 740) a verdict for the file. As described above, when a verdict for a file is reached, the verdict is distributed to the host computers and other elements of a datacenter. For instance, the centralized cloud service 130 provides verdicts to the scanning engines 120 for distribution to the hosts 110-114. In some embodiments, when the sandboxing operation is performed on a host computer by, e.g., a static analysis module, the static analysis module provides its verdict to a security analyzer for the datacenter, which then distributes the verdict to all other hosts in the datacenter.

The process then determines (at 750) whether the verdict indicates that the file contains malware. When the process determines that the file does contain malware, the file open request is denied (at 760) and the process ends. Alternatively, when the process determines that the file does not contain malware, the process transitions to open (at 770) the file. Once the file is determined to not contain malware, future attempts to open, transfer, copy, or otherwise access the file will also be allowed, based on the file's associated record indicating the verdict. Following 770, the process 700 ends.

In some embodiments, rather than being detected at the source or the destination, an edge device that serves as a gateway between a datacenter and external networks detects the file. For instance, some embodiments of the invention provide a method for preventing network spread of malware files by receiving, at an edge device that provides a connection between a datacenter and an external network, a file destined to a machine executing in the datacenter. The method determines whether the file is a known file that has been previously assessed to contain malware. Based on a determination that the file as an unknown file, the method performs an analysis on the file. Like the embodiments described above, the file cannot be opened by any machines during the analysis. When the file is determined to be a file that does not contain malware, the method allows the file to be downloaded to and opened by the particular machine.

Like the host computers in the embodiments described above, the edge device, in some embodiments, also includes a database for storing records associated with known files, as well as a static analysis module that executes within a container on the edge device to perform the sandboxing operation to analyze files. In some embodiments, when a file is determined to contain malware, the edge device prevents the file from being opened and/or transferred by any machines in the datacenter. Also, in some embodiments, the edge device allows the machine to which the file is destined to download the file, and prevents the machine from opening the file until the file is determined to not contain malware. If the downloaded file is determined to contain malware, the machine will continue to be prevented from opening the file, according to some embodiments.

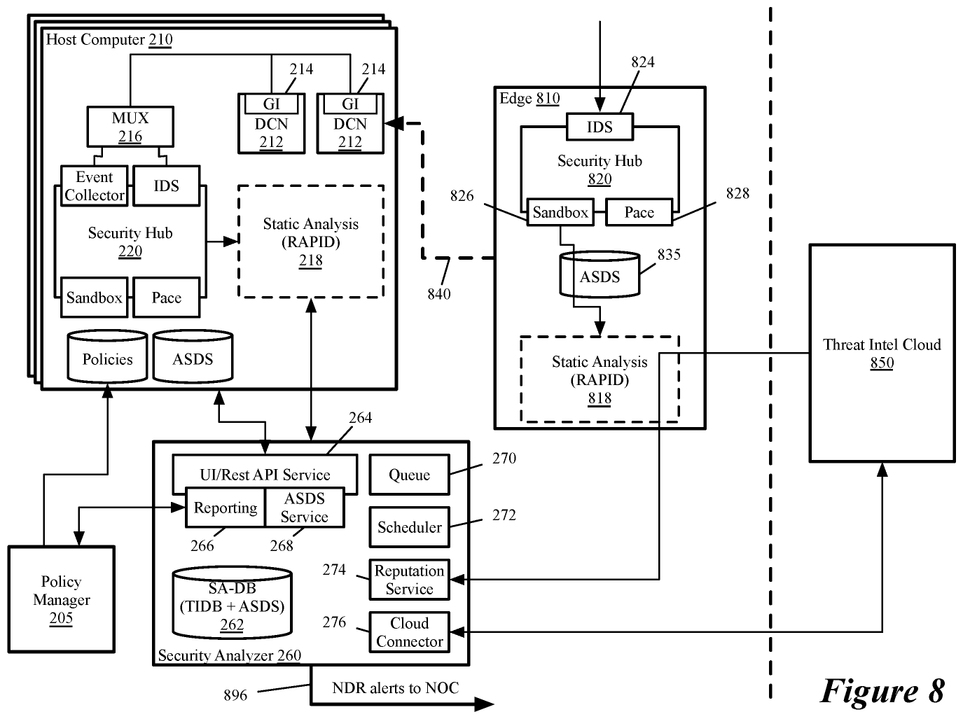

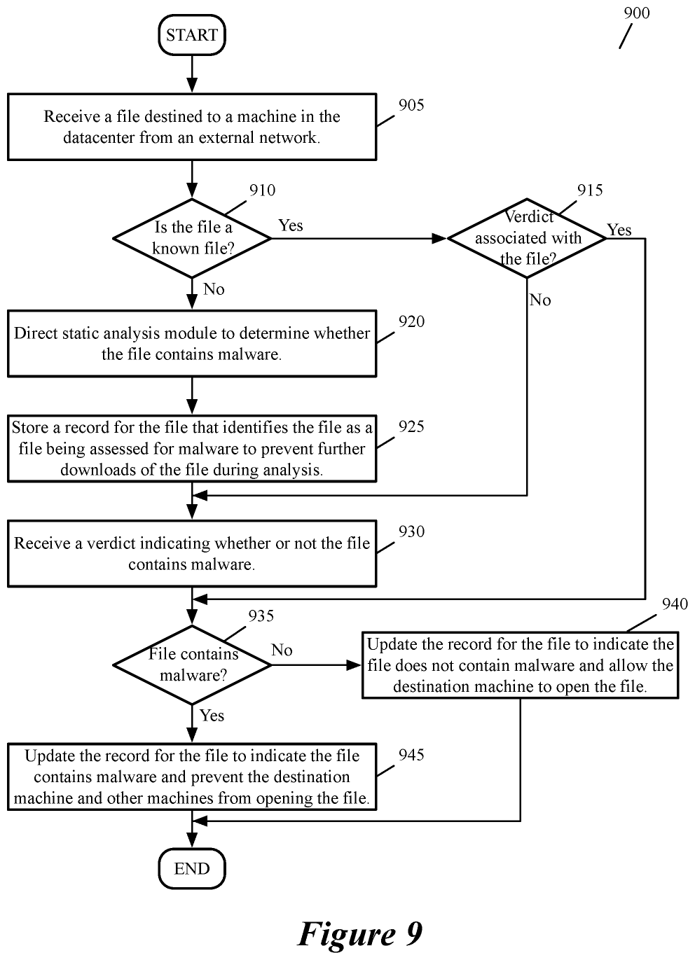

FIG. 8 conceptually illustrates a diagram of a workflow between datacenter components and a centralized cloud service for detecting and preventing network spread of malware at an edge device for the datacenter, in some embodiments. As shown, the datacenter includes host computers 210, the security analyzer 260, the policy manager 205, and an edge device 810. FIG. 8 will be further described by reference to FIG. 9 below.

FIG. 9 illustrates a process for detecting and preventing the spread of malware at an edge device that provides a connection between a datacenter and an external network, in some embodiments. The process 900 is performed, in some embodiments, by components of the edge device, such as the components of the edge device 810. The process 900 starts by receiving (at 905) a file destined to a machine in the datacenter from an external network. In some embodiments, the edge device receives the file by intercepting a data message flow that includes the file, and extracting the file from the intercepted data message flow. For instance, the edge 810 can intercept data message flows destined to machines in the datacenter, and the IDS plugin 824 of the security hub 820 on the edge 810 can then extract the file from the intercepted flow. That is, the IDS plugin 824 extracts files from intercepted flows originating from an external network, in some embodiments, in addition to performing other operations like monitoring for known malicious activity and policy violations mentioned above.

The process determines (at 910) whether the file is a known file. The security hub 820 of the edge device 810 checks the ASDS storage 835 for any records associated with the file. The ASDS storage 835 stores mappings between file hashes and verdicts associated with the files, according to some embodiments.

When the process determines (at 910) that the file is a known file, the process transitions to determine (at 915) whether there is a verdict (i.e., contains malware or does not contain malware) associated with the file. When the process determines (at 915) that there is no verdict associated with the file, the process transitions to receive (at 930) a verdict indicating whether or not the file contains malware. Alternatively, when the process determines (at 915) that there is a verdict associated with the file, the process transitions to determine (at 935) whether the verdict indicates the file contains malware.

Otherwise, when the process determines (at 910) that the file is an unknown file, the process transitions to direct (at 920) a static analysis module to determine whether the file contains malware. For instance, the sandbox plugin 826 of the security hub 820 points to the static analysis module 818, while the pace plugin 828 tracks the sandboxing progress, in some embodiments.

The process stores (at 925) a record for the file that identifies the file as a file being assessed for malware to prevent further downloads of the file during the analysis. In some embodiments, the record is received from the security analyzer 260, while in other embodiments, the record is created by the edge device 810 and stored in the ASDS storage 835. This record prevents any of the host computers 210 from downloading or opening the file. In some embodiments, steps 920 and 925 are performed concurrently, while in other embodiments, step 925 is performed prior to step 920. That is, in other embodiments, the record for the file is created and stored before the file is sent for sandboxing. In some such other embodiments, an alert indicating sandboxing is in progress for the file is sent to each host in the network to prevent any spread of the file during the analysis.

The process receives (at 930) a verdict indicating whether or not the file contains malware. The ASDS service 268 of the security analyzer 260 distributes verdicts to the host computers 210 and the edge device 810, according to some embodiment. Also, in some embodiments, the static analysis module 818 receives verdicts directly from the centralized cloud service 850.

The process determines (at 935) whether the verdict indicates the file contains malware. When the process determines (at 935) that the verdict indicates that the file does not contain malware, the process transitions to update (at 940) the record for the file to indicate the file does not contain malware and to allow the destination machine to open the file. That is, when a downloaded file is determined to be malware-free, the edge device 810 allows the download to complete, and the file to be opened by both the destination machine, and any other machines in the datacenter. Following 940, the process 900 ends.

Alternatively, when the process determines (at 935) that the verdict indicates that the file does contain malware, the process transitions to update (at 945) the record for the file to indicate the file contains malware and to prevent the destination machine and other machines from opening the file. In some embodiments, the edge device 810 allows the download of the file to be completed, but prevents any machines from opening the file. Following 945, the process 900 ends.

Similar to the EDR alerts described above for FIG. 2, the security analyzer 260 also sends network detection and response (NDR) alerts, conjunctively or alternatively, to the SOC and NOC, as indicated by the arrow 896. The NDR alerts are used to monitor and record network traffic in order to detect malicious network traffic behavior, as well as to respond to any detected or identified threats. Like the EDR alerts, in some embodiments, the NDR alerts are sent to the SOC and/or NOC in order to allow users (e.g., administrators of an enterprise network) of a UI for the SOC and/or NOC to review and determine whether to implement additional malware detection and/or prevention measures.

Many of the above-described features and applications are implemented as software processes that are specified as a set of instructions recorded on a computer-readable storage medium (also referred to as computer-readable medium). When these instructions are executed by one or more processing unit(s) (e.g., one or more processors, cores of processors, or other processing units), they cause the processing unit(s) to perform the actions indicated in the instructions. Examples of computer-readable media include, but are not limited to, CD-ROMs, flash drives, RAM chips, hard drives, EPROMs, etc. The computer-readable media does not include carrier waves and electronic signals passing wirelessly or over wired connections.

In this specification, the term “software” is meant to include firmware residing in read-only memory or applications stored in magnetic storage, which can be read into memory for processing by a processor. Also, in some embodiments, multiple software inventions can be implemented as sub-parts of a larger program while remaining distinct software inventions. In some embodiments, multiple software inventions can also be implemented as separate programs. Finally, any combination of separate programs that together implement a software invention described here is within the scope of the invention. In some embodiments, the software programs, when installed to operate on one or more electronic systems, define one or more specific machine implementations that execute and perform the operations of the software programs.

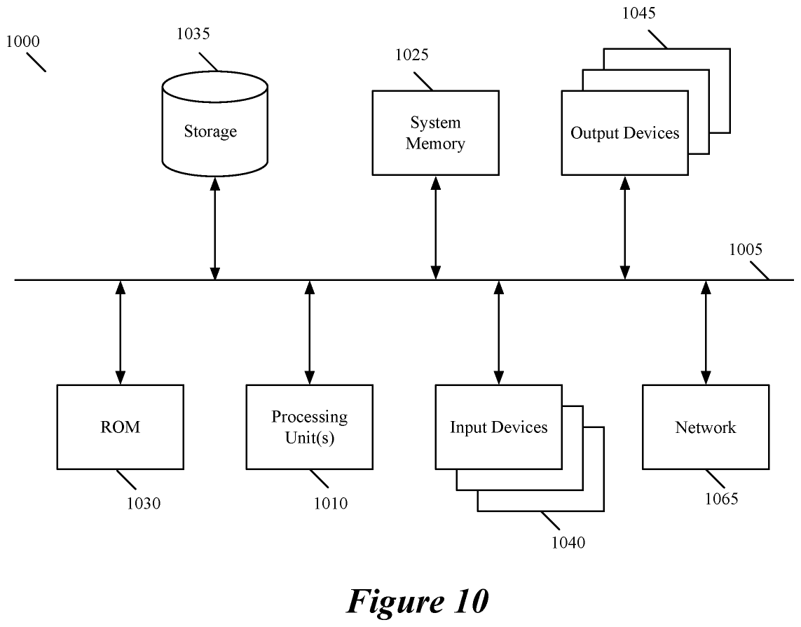

FIG. 10 conceptually illustrates a computer system 1000 with which some embodiments of the invention are implemented. The computer system 1000 can be used to implement any of the above-described hosts, controllers, gateway, and edge forwarding elements. As such, it can be used to execute any of the above described processes. This computer system 1000 includes various types of non-transitory machine-readable media and interfaces for various other types of machine-readable media. Computer system 1000 includes a bus 1005, processing unit(s) 1010, a system memory 1025, a read-only memory 1030, a permanent storage device 1035, input devices 1040, and output devices 1045.

The bus 1005 collectively represents all system, peripheral, and chipset buses that communicatively connect the numerous internal devices of the computer system 1000. For instance, the bus 1005 communicatively connects the processing unit(s) 1010 with the read-only memory 1030, the system memory 1025, and the permanent storage device 1035.

From these various memory units, the processing unit(s) 1010 retrieve instructions to execute and data to process in order to execute the processes of the invention. The processing unit(s) 1010 may be a single processor or a multi-core processor in different embodiments. The read-only-memory (ROM) 1030 stores static data and instructions that are needed by the processing unit(s) 1010 and other modules of the computer system 1000. The permanent storage device 1035, on the other hand, is a read-and-write memory device. This device 1035 is a non-volatile memory unit that stores instructions and data even when the computer system 1000 is off. Some embodiments of the invention use a mass-storage device (such as a magnetic or optical disk and its corresponding disk drive) as the permanent storage device 1035.

Other embodiments use a removable storage device (such as a floppy disk, flash drive, etc.) as the permanent storage device. Like the permanent storage device 1035, the system memory 1025 is a read-and-write memory device. However, unlike storage device 1035, the system memory 1025 is a volatile read-and-write memory, such as random access memory. The system memory 1025 stores some of the instructions and data that the processor needs at runtime. In some embodiments, the invention's processes are stored in the system memory 1025, the permanent storage device 1035, and/or the read-only memory 1030. From these various memory units, the processing unit(s) 1010 retrieve instructions to execute and data to process in order to execute the processes of some embodiments.

The bus 1005 also connects to the input and output devices 1040 and 1045. The input devices 1040 enable the user to communicate information and select commands to the computer system 1000. The input devices 1040 include alphanumeric keyboards and pointing devices (also called “cursor control devices”). The output devices 1045 display images generated by the computer system 1000. The output devices 1045 include printers and display devices, such as cathode ray tubes (CRT) or liquid crystal displays (LCD). Some embodiments include devices such as touchscreens that function as both input and output devices 1040 and 1045.

Finally, as shown in FIG. 10, bus 1005 also couples computer system 1000 to a network 1065 through a network adapter (not shown). In this manner, the computer 1000 can be a part of a network of computers (such as a local area network (“LAN”), a wide area network (“WAN”), or an Intranet), or a network of networks (such as the Internet). Any or all components of computer system 1000 may be used in conjunction with the invention.

Some embodiments include electronic components, such as microprocessors, storage and memory that store computer program instructions in a machine-readable or computer-readable medium (alternatively referred to as computer-readable storage media, machine-readable media, or machine-readable storage media). Some examples of such computer-readable media include RAM, ROM, read-only compact discs (CD-ROM), recordable compact discs (CD-R), rewritable compact discs (CD-RW), read-only digital versatile discs (e.g., DVD-ROM, dual-layer DVD-ROM), a variety of recordable/rewritable DVDs (e.g., DVD-RAM, DVD-RW, DVD+RW, etc.), flash memory (e.g., SD cards, mini-SD cards, micro-SD cards, etc.), magnetic and/or solid state hard drives, read-only and recordable Blu-Ray® discs, ultra-density optical discs, any other optical or magnetic media, and floppy disks. The computer-readable media may store a computer program that is executable by at least one processing unit and includes sets of instructions for performing various operations. Examples of computer programs or computer code include machine code, such as is produced by a compiler, and files including higher-level code that are executed by a computer, an electronic component, or a microprocessor using an interpreter.

While the above discussion primarily refers to microprocessor or multi-core processors that execute software, some embodiments are performed by one or more integrated circuits, such as application-specific integrated circuits (ASICs) or field-programmable gate arrays (FPGAs). In some embodiments, such integrated circuits execute instructions that are stored on the circuit itself.

As used in this specification, the terms “computer”, “server”, “processor”, and “memory” all refer to electronic or other technological devices. These terms exclude people or groups of people. For the purposes of the specification, the terms “display” or “displaying” mean displaying on an electronic device. As used in this specification, the terms “computer-readable medium,” “computer-readable media,” and “machine-readable medium” are entirely restricted to tangible, physical objects that store information in a form that is readable by a computer. These terms exclude any wireless signals, wired download signals, and any other ephemeral or transitory signals.

While the invention has been described with reference to numerous specific details, one of ordinary skill in the art will recognize that the invention can be embodied in other specific forms without departing from the spirit of the invention. Thus, one of ordinary skill in the art would understand that the invention is not to be limited by the foregoing illustrative details, but rather is to be defined by the appended claims.

1. A method of preventing network spread of malware files, the method comprising:
at a first host computer:
detecting an attempt to establish a file-transfer connection between a first compute machine executing on the first host computer and a second compute machine executing on a second host computer, the file transfer connection for transferring a particular file stored by the first compute machine;
delaying establishment of the file-transfer connection in order to perform an analysis of the particular file to determine whether the particular file contains malware; and
when the file is determined to contain malware, preventing the file-transfer connection from being established between the first and the second compute machines to prevent the file from being transferred.

2. The method of claim 1, wherein detecting the attempt to establish the file-transfer connection comprises receiving, from a guest introspection (GI) agent executing on the first compute machine, a notification indicating the attempt to establish the file-transfer connection.

3. The method of claim 1, wherein the analysis comprises a sandboxing operation to open, monitor, and analyze the particular file in a secure, isolated environment.

4. The method of claim 3, wherein the sandboxing operation is a first sandboxing operation performed by a static analysis module executing within a container on the host computer, the method further comprising:
determining that the static analysis module is unable to identify whether the particular file contains malware; and
redirecting the particular file through a cloud connector proxy to a centralized cloud service that performs a second sandboxing operation to determine whether the file contain malware.

5. The method of claim 4, wherein:
the centralized cloud service includes a recordation service that stores a first plurality of profiles associated with a first plurality of files that contain malware and a second plurality of profiles associated with a second plurality of files that do not contain malware; and
upon determining whether the particular file contains malware, the centralized cloud service (i) creates a record for the particular file to be stored by the recordation service and (ii) distributes the determination to at least the first and second host computers.

6. The method of claim 1, wherein during the analysis of the particular file, the particular file cannot be (i) copied, (ii) moved, (iii) uploaded, or (iv) transferred across systems.

7. The method of claim 1, wherein the first and second host computers are a same host computer.

8. The method of claim 1, wherein the first host computer executes in a first datacenter and the second host computer executes in a second datacenter.

9. The method of claim 1, wherein the first and second host computers execute in a same datacenter.

10. The method of claim 1, wherein:
the first compute machine comprises one of a virtual machine, a container, and a pod; and
the second compute machine comprises one of a virtual machine, a container, and a pod.

11. A non-transitory machine readable medium of a first host computer storing a program for execution by a set of processing units of the first host computer, the program for preventing network spread of malware files, the program comprising sets of instructions for:
detecting an attempt to establish a file-transfer connection between a first compute machine executing on the first host computer and a second compute machine executing on a second host computer, the file transfer connection for transferring a particular file stored by the first compute machine;
delaying establishment of the file-transfer connection in order to perform an analysis of the particular file to determine whether the particular file contains malware;
when the file is determined to contain malware, preventing the file-transfer connection from being established between the first and the second compute machines to prevent the file from being transferred; and
when the file is determined not to contain malware, allowing the file-transfer connection to be established between the first and second compute machines to transfer the file.

12. The non-transitory machine readable medium of claim 11, wherein the set of instructions for detecting the attempt to establish the file-transfer connection comprises a set of instruction for receiving, from a guest introspection (GI) agent executing on the first compute machine, a notification indicating the attempt to establish the file-transfer connection.

13. The non-transitory machine readable medium of claim 11, wherein the analysis comprises a sandboxing operation to open, monitor, and analyze the particular file in a secure, isolated environment.

14. The non-transitory machine readable medium of claim 13, wherein the sandboxing operation is a first sandboxing operation performed by a static analysis module executing within a container on the host computer, the program further comprising sets of instructions for:
determining that the static analysis module is unable to identify whether the particular file contains malware; and
redirecting the particular file through a cloud connector proxy to a centralized cloud service that performs a second sandboxing operation to determine whether the file contain malware.

15. The non-transitory machine readable medium of claim 14, wherein:
the centralized cloud service includes a recordation service that stores a first plurality of profiles associated with a first plurality of files that contain malware and a second plurality of profiles associated with a second plurality of files that do not contain malware; and
upon determining whether the particular file contains malware, the centralized cloud service (i) creates a record for the particular file to be stored by the recordation service and (ii) distributes the determination to at least the first and second host computers.

16. The non-transitory machine readable medium of claim 11, wherein during the analysis of the particular file, the particular file cannot be (i) copied, (ii) moved, (iii) uploaded, or (iv) transferred across systems.

17. The non-transitory machine readable medium of claim 11, wherein the first and second host computers are a same host computer.

18. The non-transitory machine readable medium of claim 11, wherein the first host computer executes in a first datacenter and the second host computer executes in a second datacenter.

19. The non-transitory machine readable medium of claim 11, wherein the first and second host computers execute in a same datacenter.

20. The non-transitory machine readable medium of claim 11, wherein:
the first compute machine comprises one of a virtual machine, a container, and a pod; and
the second compute machine comprises one of a virtual machine, a container, and a pod.
